(19) United States
(12) Patent Application Publication
(10) Pub. No.: US 2003/0204653 A1
(43) Pub. Date: Oct. 30, 2003

(54) Network switching device and network switching method

(75) Inventor: Taul Katayama, Kanagawa (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/351,342

(22) Filed: Jan. 27, 2003

(30) Foreign Application Priority Data
Apr. 25, 2002 (JP) 2002-124156

(51) Int. Cl. G06F 3/00

(52) U.S. Cl. 710/52

(57) ABSTRACT

A network switching device which can guarantee transfer quality of packets having high priority. A priority determination circuit determines a priority of received data when the received data is input. An amount-of-use detection circuit determines whether or not an amount of current use of a buffer exceeds a threshold value which is associated with each priority in advance. A data transfer circuit stores the received data in the buffer when the amount of current use of the buffer does not exceed the threshold value associated with the priority of the received data. Thus, it is possible to store only received data having high priority in the buffer when free capacity of the buffer becomes small.

### CROSS-REFERENCE TO RELATED APPLICATIONS

This application is based upon and claims the benefits of priority from the prior Japanese Patent Application No.2002-124156, filed on Apr. 25, 2002, the entire contents of which are incorporated herein by reference.

### BACKGROUND OF THE INVENTION

1) Field of the Invention

The present invention relates to a network switching device and a network switching method which transfer data between a plurality of networks, and in particular, to a network switching device and a network switching method based on a store-and-forward mechanism.

2) Description of the Related Art

In wide area networks such as the Internet, a large-scale information-and-communication environment is constructed by interconnecting a large number of networks. In many cases where a plurality of networks are interconnected, network switching devices are used. Each network switching device has a plurality of ports for connection to networks, receives a packet through a port, refers to a destination address of the received packet, and outputs the packet through another port corresponding to the destination.

The so-called store-and-forward method is known as a switching method executed by network switching devices. In the store-and-forward method, network switching devices store a received packet and error-check the received packet. If an error arises, the received packet is discarded. In the network switching devices using the store-and-forward method, for example, a shared buffer is used. In such a case, the network switching device temporarily stores a received packet in the shared buffer, and then the network switching device outputs the stored packet through a port to which a destination node is connected.

Generally, the storage capacities of shared buffers built in network switching devices are limited. Therefore, when traffic concentration from a plurality of input ports increases output traffic at an output port, and the high output traffic continues, free spaces in the shared buffer are exhausted. In such a case, packets which are input after the shared buffer are exhausted are discarded.

FIG. 17 is a flow diagram indicating an example of processing in accordance with a conventional store-and-forward method. FIG. 17 shows state transitions in data transfer processing in the case where excessive packet inflow continues and free buffer spaces are exhausted. The processing in FIG. 17 is explained below step by step.

[Step S101] The network switching device transfers to a shared buffer all data received from networks, when the amount of use of the shared buffer is still small and no congestion occurs.

[Step S102] The network switching device detects a state in which excessive packet inflow continues and free spaces of the shared buffer are exhausted. For example, when the free capacity of the shared buffer falls below a threshold value which is preset, the network switching device determines that free spaces of the shared buffer are exhausted.

[Step S103] The network switching device outputs a reception reject signal.

[Step S104] The network switching device masks all reception requests while the reception reject signal is output. The word “mask” means not to receive data and to discard data.

As described above, when the free spaces of the shared buffer are exhausted, data which reach the network switching device after the exhaustion are discarded. This situation continues until at least a predetermined amount of space becomes available in the shared buffer.

Incidentally, information transmitted through a network includes information for which data quality at or above a predetermined level is required to be maintained and other information for which specific data quality is not required. Therefore, it is possible to assign a priority to each packet according to information conveyed by the packet. For example, it is possible to define a plurality of priority classes by classifying the priority into a plurality of ranks, and assign to each packet a priority class according to an attribute (e.g., a source address) of the packet. The network switching devices preferentially transfer packets of high priority classes. According to this provision, it is possible to improve reliability of data transfer by the packets having high priority.

However, even in the case where the priorities are assigned to the packets, free spaces of the shared buffer are exhausted when congestion occurs and traffic consisting of packets of low priority classes concentrates on an output port. In this case, packet discard occurs irrespective of the priorities. That is, increase in received data having low priority adversely affects transfer quality of received data having high priority.

### SUMMARY OF THE INVENTION

The present invention is made in view of the above problems, and the object of the present invention is to provide a network switching device and a network switching method which can guarantee transfer quality of packets having high priority.

In order to accomplish the above object, a network switching device for transferring data between a plurality of networks is provided. The network switching device comprises: a buffer; a priority determination circuit which determines a priority of received data when the received data is input; an amount-of-use detection circuit which determines whether or not an amount of current use of the buffer exceeds a threshold value which is associated with each priority in advance; and a data transfer circuit which acquires results of determination by the priority determination circuit and the amount-of-use detection circuit, and stores the received data in the buffer when the amount of current use of the buffer does not exceed the threshold value associated with the priority of the received data.

The above and other objects, features and advantages of the present invention will become apparent from the following description when taken in conjunction with the accompanying drawings which illustrate preferred embodiment of the present invention by way of example.

### BRIEF DESCRIPTION OF THE DRAWINGS

In the drawings:

FIG. 1 is a conceptual diagram illustrating the invention which is realized in embodiments;

FIG. 2 is a diagram illustrating examples of connections to a network switching device as a first embodiment;

FIG. 3 is a block diagram illustrating an internal construction of the network switching device;

FIG. 4 is a block diagram illustrating an example of a construction of a priority-class determination circuit;

FIG. 5 is a block diagram illustrating an example of a construction of an amount-of-use-of-shared-buffer detection circuit;

FIG. 6 is a flow diagram indicating a flow of a packet in the network switching device in the case where no congestion occurs;

FIG. 7 is a flow diagram indicating examples of transitions between packet transfer states in the case where congestion occurs;

FIG. 8 is a diagram illustrating an example of a construction of a network switching device as a second embodiment;

FIG. 9 is a diagram illustrating an example of a construction of a network switching device as a third embodiment;

FIG. 10 is a diagram illustrating an example of a system construction in a fourth embodiment;

FIG. 11 is a flow diagram indicating an example of a sequence of processing for priority control in a processor when a connection is newly established;

FIG. 12 is a diagram illustrating an example of a system construction in a fifth embodiment;

FIG. 13 is a diagram illustrating an example of a system construction in a sixth embodiment;

FIG. 14 is a diagram illustrating an example of a system construction in a seventh embodiment;

FIG. 15 is a diagram illustrating an example of a system construction in an eighth embodiment;

FIG. 16 is a block diagram illustrating an example of a construction of a priority-class determination circuit which outputs an interrupt signal; and

FIG. 17 is a flow diagram indicating an example of processing for a conventional store-and-forward method.

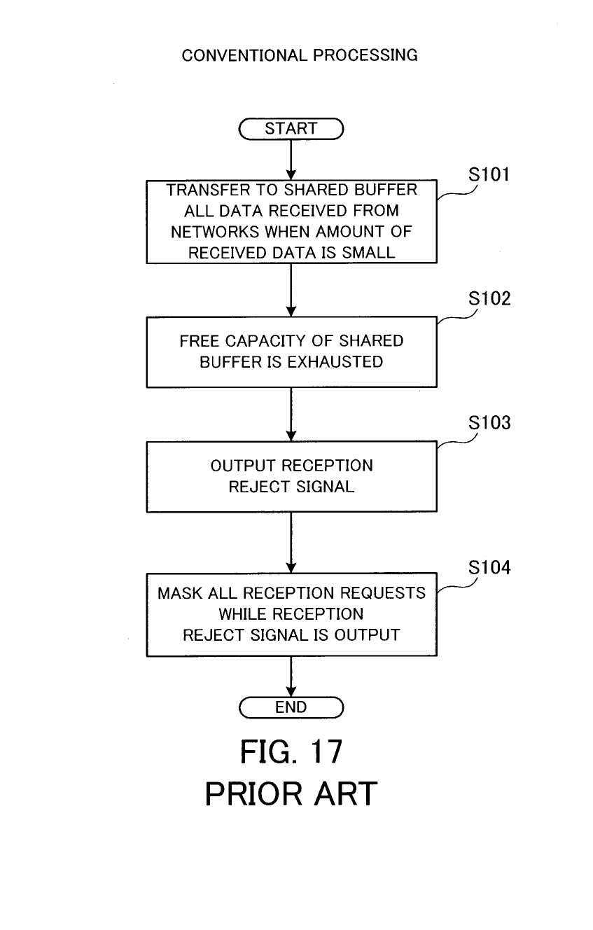

### DESCRIPTION OF THE PREFERRED EMBODIMENTS

Embodiments of the present invention are explained in detail below with reference to drawings.

First, an outline of the invention which is realized in the embodiments is explained, and thereafter details of the embodiments are explained.

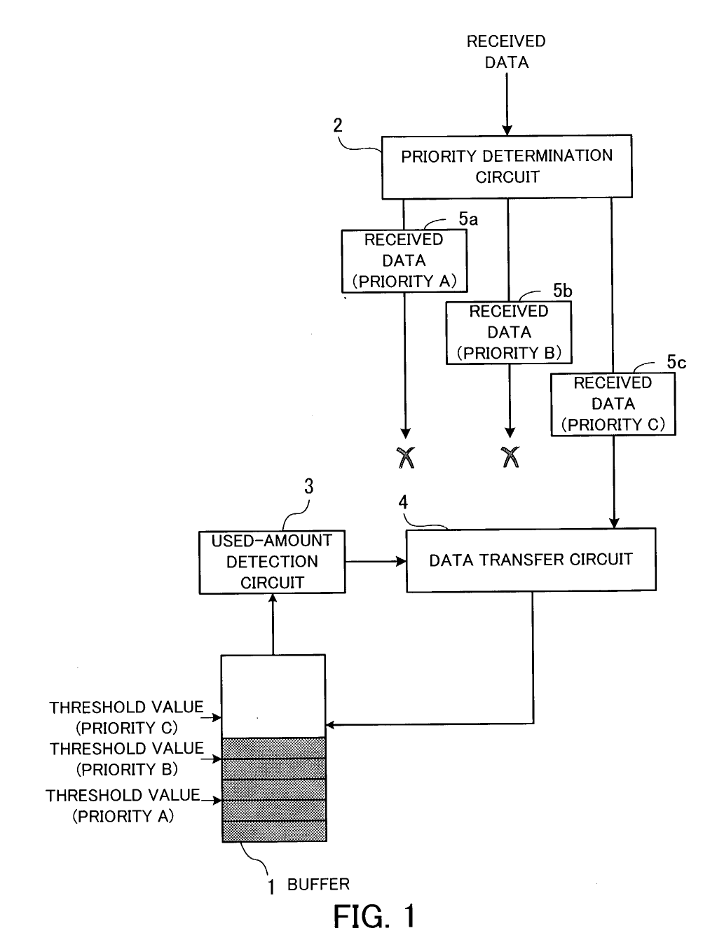

FIG. 1 is a conceptual diagram illustrating the invention which is realized in the embodiments. As illustrated in FIG. 1, the network switching device comprises a buffer 1, a priority determination circuit 2, an amount-of-use detection circuit 3, and a data transfer circuit 4.

The buffer 1 is a storage device for storing received data.

The priority determination circuit 2 determines priorities of received data items 5a to 5c when the received data items 5a to 5c are input. For example, correspondences between attributes (such as source addresses or destination addresses) of data items and priorities are stored in advance in the priority determination circuit 2. The priority determination circuit 2 determines the priorities which are respectively associated with the attributes of the received data items 5a to 5c. In the example of FIG. 1, three priorities A, B, and C are defined in increasing order. The priority determination circuit 2 passes the priority of the received data to the data transfer circuit 4.

The amount-of-use detection circuit 3 determines whether or not the amount of current use of the buffer 1 exceeds a threshold value which is associated with each priority in advance. For example, the amount-of-use detection circuit 3 determines whether or not the amount of current use of the buffer 1 exceeds a threshold value associated with the priority A, a threshold value associated with the priority B, and a threshold value associated with the priority C. Greater threshold values are associated with higher priorities. In the example illustrated in FIG. 1, the amount of current use of the buffer 1 exceeds the threshold values associated with the priorities A and B, and does not exceed the threshold value associated with the priority C.

The amount-of-use detection circuit 3 sends the determination result to the data transfer circuit 4. For example, when the amount of current use of the buffer 1 exceeds a threshold value associated with a priority, the amount-of-use detection circuit 3 sends to the data transfer circuit 4 a reception reject signal for the respective priority.

The data transfer circuit 4 acquires the determination results of the priority determination circuit 2 and the amount-of-use detection circuit 3, and stores received data in the buffer 1 when the amount of current use of the buffer 1 does not exceed a threshold value associated with a priority of the received data. That is, in the example of FIG. 1, only the received data item 5c having the priority C is stored in the buffer 1, and the received data items 5a and 5b having the priorities A and B are discarded without being stored in the buffer 1.

In the above network switching device, the priority of received data is determined by the priority determination circuit 2, and the amount-of-use detection circuit 3 determines whether or not the amount of current use of the buffer 1 exceeds a threshold value which is associated with each priority in advance. When the amount of current use of the buffer 1 does not exceed a threshold value which is associated with the priority of the received data, the received data is stored by the data transfer circuit 4 in the buffer 1.

Thus, when congestion occurs and the free capacity of the buffer 1 becomes small, only received data having high priority can be stored in the buffer 1. Therefore, the quality of the received data having high priority can be guaranteed. In addition, as illustrated in FIG. 1, when the priorities are set stepwise, communication having higher priority can be guaranteed with higher reliability.

Hereinbelow, details of the embodiments of the present invention are explained.

[First Embodiment]

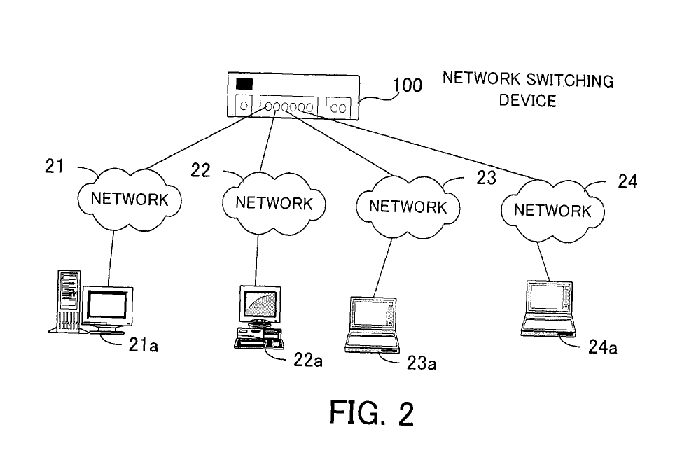

FIG. 2 is a diagram illustrating examples of connections to a network switching device as the first embodiment. As illustrated in FIG. 2, the network switching device 100 has a plurality of communication ports respectively connected to a plurality of networks 21 to 24, and a plurality of terminals 21a, 22a, 23a, and 24a are respectively connected to the networks 21 to 24.

The network switching device 100 transfers packets between the networks connected to the network switching device 100. For example, a packet output from the terminal 21a addressed to the terminal 22a is input into the network switching device 100 through the network 21, and the network switching device 100 outputs the packet to the network 22. Then, the terminal 22a receives the packet output to the network 22.

In the first embodiment, processing of packets transferred from a network to another network is explained in detail.

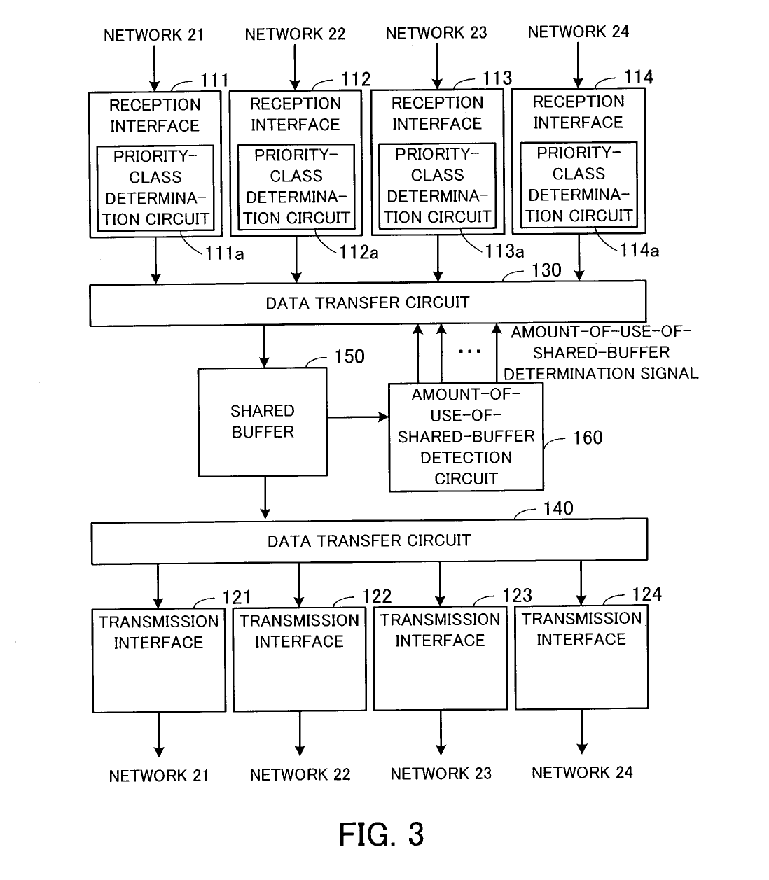

FIG. 3 is a block diagram illustrating an internal construction of the network switching device. In the network switching device 100, a plurality of reception interfaces 111 to 114 are connected to the networks 21 to 24, respectively. In addition, a plurality of transmission interfaces 121 to 124 are also connected to the networks 21 to 24, respectively.

The reception interfaces 111 to 114 are also connected to a data transfer circuit 130, and the transmission interfaces 121 to 124 are also connected to a data transfer circuit 140. In addition, a shared buffer 150 is connected between the data transfer circuits 130 and 140. Further, an amount-of-use-of-shared-buffer detection circuit 160 is connected between the data transfer circuit 130 and the shared buffer 150.

The reception interfaces 111 to 114 are communication interfaces for receiving packets transmitted through the networks 21 to 24. When the reception interfaces 111 to 114 receive packets from the networks 21 to 24, the reception interfaces 111 to 114 send reception requests for the packets to the data transfer circuit 130.

In addition, the reception interfaces 111 to 114 include priority-class determination circuits 111a, 112a, 113a, and 114a, respectively. The priority-class determination circuits 111a, 112a, 113a, and 114a determine priority classes of packets received by the reception interfaces 111 to 114, respectively. The packets can be classified into groups, and the priority classes indicate the priorities of the respective groups of packets, and can be determined by referring to header information or the like in the packets. For example, a packet transmitted from a terminal having a certain address which is preset is determined to belong to a high priority class (i.e., have high priority). The priority classes of the packets are inserted by the reception interfaces 111 to 114 in the reception requests which are passed to the data transfer circuit 130.

When the data transfer circuit 130 allows reception of data, the reception interfaces 111 to 114 pass the received packets to the data transfer circuit 130.

The transmission interfaces 121 to 124 are communication interfaces for transmitting packets through the networks 21 to 24. When each of the transmission interfaces 121 to 124 becomes able to transmit a packet, the transmission interface passes a transmission request to the data transfer circuit 140. When each of the transmission interfaces 121 to 124 receives a packet from the data transfer circuit 140, the transmission interface transmits the packet to one of the networks 21 to 24 corresponding to the transmission interface.

The data transfer circuit 130 selects an appropriate reception interface in response to the reception requests from the reception interfaces 111 to 114. The data transfer circuit 130 receives a packet from the selected reception interface, and stores the packet in the shared buffer 150. For example, the data transfer circuit 130 is constituted by a switch, a shared bus, an arbiter, and the like.

In addition, when the data transfer circuit 130 receives from the amount-of-use-of-shared-buffer detection circuit 160 a notification that the amount of current use of the shared buffer 150 exceeds a threshold value, the data transfer circuit 130 masks packets of the priority class corresponding to the threshold value. The word “mask” means to reject reception. When reception of a packet is rejected, the packet is discarded.

Specifically, the data transfer circuit 130 recognizes a priority class which can be currently stored in the shared buffer 150, based on an amount-of-use-of-shared-buffer determination signal which is passed from the amount-of-use-of-shared-buffer detection circuit 160. When the data transfer circuit 130 receives a reception request for a packet from a reception interface, the data transfer circuit 130 determines whether or not the packet is allowed to be stored in the shared buffer 150, based on the priority class of the packet. When the packet is allowed to be stored, the data transfer circuit 130 receives the packet from the reception interface, and stores the packet in the shared buffer 150. When the packet belongs to a priority class which is not allowed to be stored, the data transfer circuit 130 notifies the reception interface of rejection of reception, or stops an operation for the reception (i.e., ignores the reception request).

When the data transfer circuit 130 stops the operation for reception, packets stop in the reception interface which receives rejection of the reception request. Therefore, packets which cannot be stored in the reception interface are discarded.

On the other hand, in response to a transmission request from the transmission interfaces 121 to 124, the data transfer circuit 140 acquires a packet from the shared buffer 150, and passes the packet to a transmission interface connected to a terminal as a destination of the packet. For example, the data transfer circuit 140 is constituted by a switch, a shared bus, an arbiter, and the like.

The shared buffer 150 is a buffer memory for temporarily storing transferred packets. In the shared buffer 150, packets of various priority classes received by the reception interfaces 111 to 114 are stored.

The amount-of-use-of-shared-buffer detection circuit 160 monitors the status of use of the shared buffer 150, and determines whether or not the amount of current use of the buffer 150 exceeds a predetermined threshold value, which is a maximum amount (allowed value) of use of the shared buffer and is preset in advance associated with each priority class. Each packet is not allowed to be stored in the shared buffer 150 when the amount of current use of the shared buffer 150 exceeds the threshold value which is set for the priority class of the packet. In addition, the amount-of-use-of-shared-buffer detection circuit 160 sends to the data transfer circuit 130 an amount-of-use-of-shared-buffer determination signal indicating whether or not packets of each priority class is allowed to be stored in the shared buffer 150.

The amount-of-use-of-shared-buffer detection circuit 160 and the data transfer circuit 130 are connected with a plurality of signal lines, each of which corresponds to a priority class. The “1” or “0” output on each signal line indicates whether or not packets of a priority class corresponding to the signal line is allowed to be stored.

In the network switching device 100 having the above construction, switching processing including the determination whether or not packet transfer is allowed is performed according to the priority class. For example, when a packet which is to be transferred from the network 21 to the network 22 is input, the priority class of the packet is determined by the reception interface 111, and a reception request including the priority class of the packet is passed to the data transfer circuit 130.

Then, the data transfer circuit 130 compares the priority class of the packet with the amount-of-use-of-shared-buffer determination signal, and determines whether or not the packet of the priority class is allowed to be stored in the shared buffer 150. When storing is allowed, reception of the packet is allowed, and the packet is stored by the data transfer circuit 130 in the shared buffer 150. When storing is not allowed, the reception of the packet is rejected, and the reception interface 111 discards the packet.

Each packet stored in the shared buffer 150 is passed by the data transfer circuit 140 to the transmission interface 122 corresponding to the destination of the packet. When a packet is passed to the transmission interface 122, a region of the shared buffer 150 from which the packet is read out is released (i.e., the region becomes free). The transmission interface 122 which receives the packet outputs the packet to the network 22.

Thus, packet transfer can be controlled so as to be allowed and rejected according to each priority class. In addition, the output from the amount-of-use-of-shared-buffer detection circuit 160 to the data transfer circuit 130 through a signal line for each priority class indicates whether or not packets of each priority class are allowed to be stored. Therefore, it is possible to notify the data transfer circuit 130 whether or not packets of each priority class are allowed to be stored, on a real-time basis according to variations in the amount of use of the shared buffer 150.

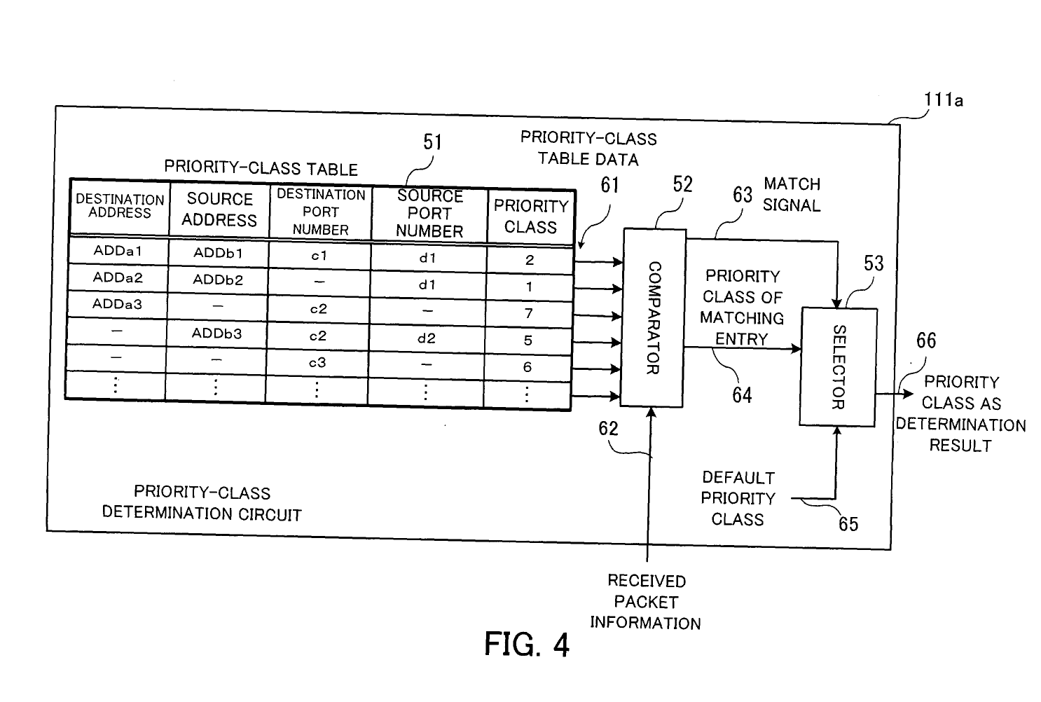

FIG. 4 is a block diagram illustrating an example of a construction of one of the priority-class determination circuits. As illustrated in FIG. 4, the priority-class determination circuit 111a comprises a priority-class table 51, a comparator 52, and a selector 53. The comparator 52 is connected to the priority-class table 51 and the selector 53.

The priority-class table 51 is definition information for determining priorities of packets. The priority-class table 51 is a data table having a plurality of fields for registering information on a plurality of attributes of packets for which setting of a priority class is required, and a field for setting the priority class.

In the example of FIG. 4, the priority-class table 51 includes fields for “DESTINATION ADDRESS,” “SOURCE ADDRESS,” “DESTINATION PORT NUMBER,” “SOURCE PORT NUMBER,” and “PRIORITY CLASS.” Data items in the respective fields on each row are associated with each other, and constitute an entry.

In the field “DESTINATION ADDRESS,” destination addresses of packets the priority classes of which are to be determined are set. In the example of FIG. 4, addresses “ADDa1,” “ADDa2,” “ADDa3,” and the like are set in the field “DESTINATION ADDRESS.”

In the field “SOURCE ADDRESS,” source addresses of packets the priority classes of which are to be determined are set. In the example of FIG. 4, addresses “ADDb1,” “ADDb2,” “ADDb3,” and the like are set in the field “SOURCE ADDRESS.”

In the field “DESTINATION PORT NUMBER,” destination port numbers of packets the priority classes of which are to be determined are set. For example, in the case of TCP (Transmission Control Protocol) communication, the destination port numbers are TCP destination port numbers. The port number is information for discriminating between applications with which communication based on the TCP protocol is performed. Therefore, when the port number is designated, it is possible to determine to which application a packet is to be passed. In the example of FIG. 4, port numbers “c1,” “c2,” “c3,” and the like are set in the field “DESTINATION PORT NUMBER.”

In the field “SOURCE PORT NUMBER,” source port numbers of packets the priority classes of which are to be determined are set. In the example of FIG. 4, port numbers “d1,” “d2,” and the like are set in the field “SOURCE PORT NUMBER.”

In the field “PRIORITY CLASS,” a priority class of packets which match with information set in the other fields in each entry is set. In the first embodiment, the priority class is indicated by a natural number, and smaller numbers correspond to higher priorities. That is, the priority class “1” corresponds to the highest priority. In the example of FIG. 4, the priority class “2” is set corresponding to the destination address “ADDa1,” the source address “ADDb1,” the destination port number “c1,” and the source port number “d1.”

In each entry in the priority-class table 51, it is sufficient that information is set in the field “PRIORITY CLASS” and at least one other field. That is, it is not necessary to set information in all of the above fields. In such a case, the priority class is determined by referring to only fields in which information is set. For example, the priority class “1” is set corresponding to the destination address “ADDa2,” the source address “ADDb2,” and the source port number “d1.” Since no destination port number is set in this entry, the destination port number is not referred to in the determination of the priority class of a packet.

The field items indicated in the priority-class table 51 in FIG. 4 are examples, and it is possible to provide other fields for various attributes. For example, when other information items such as a connection identifier, service quality, a protocol identifier, and an application identifier are set in the priority-class table 51, these information items can be used for determination of the priority class.

The information (priority-class table data 61) set in the priority-class table 51 is passed to the comparator 52 on an entry-by-entry basis.

The comparator 52 compares information on a received packet (received packet information 62) with each entry (except for the information in the field “PRIORITY CLASS”) in the priority-class table 51. When a matching entry is found in the priority-class table 51, the comparator 52 asserts the match signal 63. At this time, the comparator 52 outputs to the selector 53 a priority class which is set in the field “PRIORITY CLASS” in the matching entry.

The selector 53 outputs a result of determination of the priority class of the received packet. Specifically, when the comparator 52 confirms a matching entry (i.e., asserts the match signal 63), the selector 53 outputs as a determination result 66 a priority class 64 acquired from the field “PRIORITY CLASS” in the matching entry in the priority-class table 51. When no match is found, the selector 53 outputs as the determination result 66 a default priority class 65, which is preset. For example, it is possible to set as the default priority class 65 a value which is greater than any values set in the field “PRIORITY CLASS” in the priority-class table 51 (i.e., a value indicating a priority lower than any priorities indicated in the field “PRIORITY CLASS). It is possible to set a unique value as the default priority class 65 in the reception interface 111, or set a value common to the reception interfaces 111 to 114 in another element in the network switching device 100.

In the priority-class determination circuit 111a having the above construction, when the received packet information 62 (e.g., the contents of the received packet information in a packet) is input from the reception interface 111, the comparator 52 compares the received packet information 62 with each entry in the priority-class table 51. When a matching entry is found as a result of the comparison, the match signal 63 is asserted, and the priority class 64 acquired from the field “PRIORITY CLASS” in the matching entry is passed to the selector 53. Then, the selector 53 outputs the priority class 64 as the determination result 66.

On the other hand, when no matching entry is found as a result of the comparison, the match signal 63 remains negated. Then, the selector 53 outputs the default priority class 65 as the determination result 66.

Thus, the priority-class determination circuit 111a determines the priority class of the packet received by the reception interface 111. Although the priority-class determination circuit 111a in the reception interface 111 is indicated in FIG. 4 as an example, the other priority-class determination circuits 112a, 113a, and 114a in the reception interfaces 112 to 114 can be realized in a similar manner to the priority-class determination circuit 111a. The contents (i.e., the respective fields and information items) of the priority-class table 51 in the priority-class determination circuits 111a, 112a, 113a, and 114a can be set individually. In addition, an arbitrary value can also be set as the default priority class 65 in each of the reception interfaces 111 to 114. For example, it is possible to set as the default priority class 65 a value common to all of the reception interfaces 111 to 114.

Next, an internal construction of the shared buffer 150 and a construction of the amount-of-use-of-shared-buffer detection circuit 160 are explained.

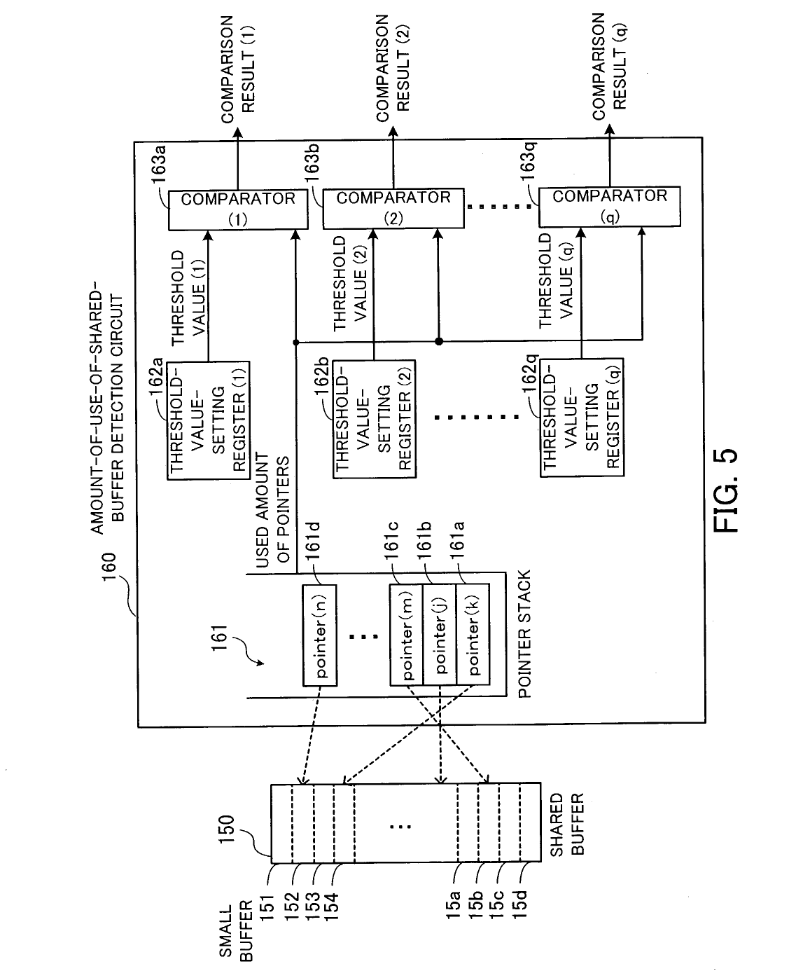

FIG. 5 is a block diagram illustrating an example of a construction of the amount-of-use-of-shared-buffer detection circuit. In order to monitor the amount of use of the shared buffer, the amount-of-use-of-shared-buffer detection circuit 160 has the construction as illustrated in FIG. 5.

The shared buffer 150 are partitioned into a plurality of storage regions by a definition of an address space. Hereinbelow, the storage regions produced by the partition are referred to as small buffers 151 to 154 . . . and 15a to 15d. Each of the small buffers 151 to 154 . . . and 15a to 15d are storage regions for storing packets which are to be transferred.

In order to monitor the amount of use of the shared buffer 150, the amount-of-use-of-shared-buffer detection circuit 160 comprises a pointer stack 161, a plurality of threshold-value-setting registers 162a, 162b, . . . 162q, and a plurality of comparators 163a, 163b, . . . 163q.

The pointer stack 161 is a stack for storing pointers 161a to 161d pointing to the small buffers 151 to 154 . . . and 15a to 15d in the shared buffer 150. When one of the small buffers 151 to 154 . . . and 15a to 15d is used, i.e., when a received packet is written in the shared buffer 150, a pointer pointing to the small buffer is popped from the pointer stack 161, and therefore the number of pointers in the pointer stack 161 decreases.

On the other hand, when one of the small buffers 151 to 154 . . . and 15a to 15d is released, i.e., when a transmission packet is read out from the shared buffer 150, a pointer which has been used for the packet is pushed into the pointer stack 161, and therefore the number of pointers in the pointer stack 161 increases. Thus, the amount of use of the shared buffer 150 can be determined by determining the number of pointers in the pointer stack 161.

The threshold-value-setting registers 162a, 162b, . . . 162q are registers for setting values (threshold values) which indicate allowable amounts of use of the shared buffer 150 corresponding to each priority class. The number of the threshold-value-setting registers 162a, 162b, . . . 162q is at least one. In the example of FIG. 5, the number is q. The threshold values set in the threshold-value-setting registers 162a, 162b, . . . 162q are output to the comparators 163a, 163b, . . . 163q, respectively.

The comparators 163a, 163b, . . . 163q compares the amount of use of pointers with the threshold values output from the respectively corresponding threshold-value-setting registers 162a, 162b, . . . 162q. Then, the comparators 163a, 163b, . . . 163q output the results of the comparison. Specifically, each of the comparators 163a, 163b, . . . 163q asserts a signal indicating the result of the comparison when the amount of use of pointers exceeds the corresponding threshold value.

In the amount-of-use-of-shared-buffer detection circuit 160 having the above construction, when a received packet is stored in the shared buffer 150, a pointer pointing to a small buffer in which the packet is stored is popped from the pointer stack 161. On the other hand, when a packet in the shared buffer 150 is transmitted, a pointer pointing to a small buffer from which the packet is read out is pushed into the pointer stack 161.

Information indicating the amount of use of pointers in the pointer stack 161 is input into the comparators 163a, 163b, . . . 163q. Then, the comparators 163a, 163b, . . . 163q compares the amount of use of pointers with the values in the respectively corresponding threshold-value-setting registers 162a, 162b, . . . 162q, and output the results of the comparison.

Thus, it is possible to observe the amount of use of the shared buffer 150, and determine whether or not the amount of use of the shared buffer 150 exceeds the threshold value assigned to each priority class.

Next, processing in the network switching device 100 is explained with reference to a flow diagram.

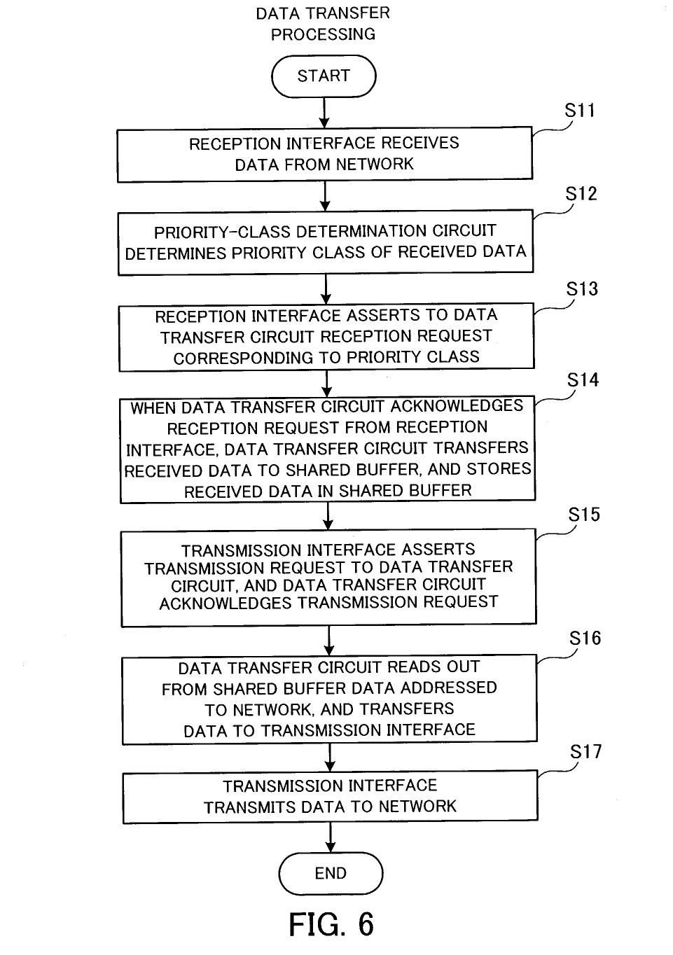

FIG. 6 is a flow diagram indicating a flow of a packet in the network switching device in the case where no congestion occurs. The processing indicated in FIG. 6 is explained step by step for a case where a packet is transferred from the network 21 to the network 22.

[Step S11] The reception interface 111 receives a packet from the network 21.

[Step S12] The priority-class determination circuit 111a in the reception interface 111 determines the priority class of the received packet.

[Step S13] The reception interface 111 asserts a reception request to the data transfer circuit 130 corresponding to the determined priority class. The reception request contains the priority class.

[Step S14] When the data transfer circuit 130 acknowledges the reception request, the data transfer circuit 130 transfers the received packet from the reception interface 111 to the shared buffer 150, and stores the received packet in the shared buffer 150.

[Step S15] The transmission interface 122 asserts a transmission request to the data transfer circuit 140. Then, the data transfer circuit 140 acknowledges the transmission request.

[Step S16] The data transfer circuit 140 reads out from the shared buffer 150 a packet addressed to the network 22, and transfers the packet to the transmission interface 122.

[Step S17] The transmission interface 122 transmits the packet to the network 22.

Thus, the packet is transferred through the network switching device 100.

When packet congestion occurs due to rapid increase in traffic, packets of the respective priority classes become subject to rejection of reception in increasing order of the priority classes. For example, a state in which the amount of data input into the reception interfaces 111 to 114 per unit time is greater than the amount of data transmitted by the transmission interfaces 121 to 124 per unit time continues, the amount of use of the shared buffer 150 increases. In addition, when the amount of use of the shared buffer 150 exceeds at least one of the threshold value, reception of packets of at least one priority class corresponding to the at least one of the threshold value is rejected.

Hereinbelow, examples of transitions between packet transfer states are explained.

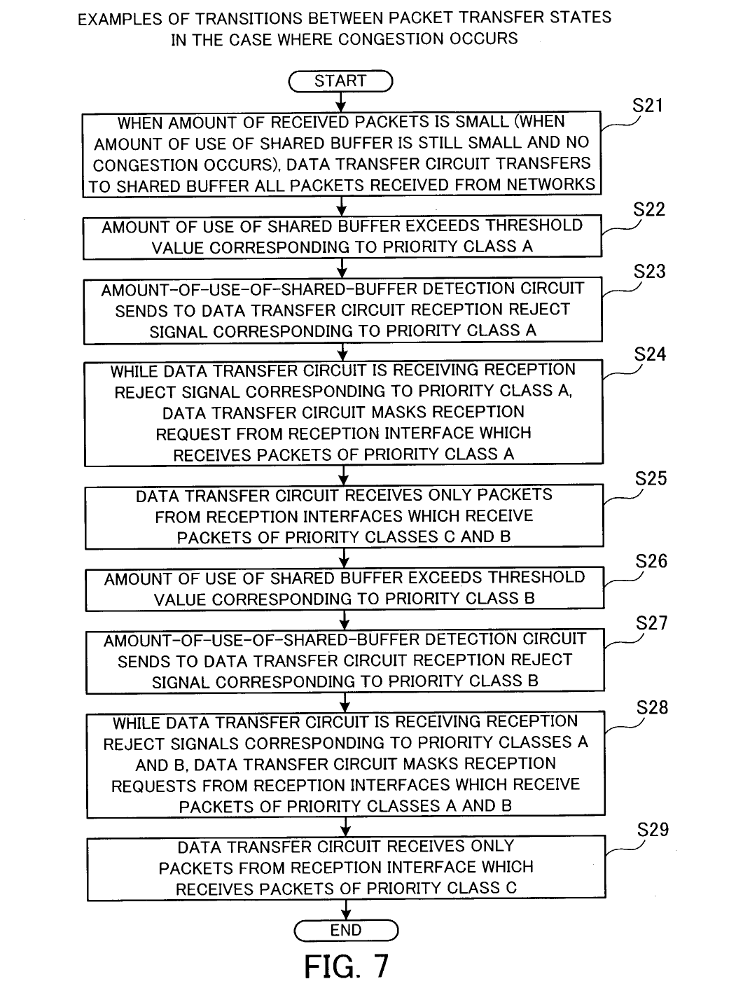

FIG. 7 is a flow diagram indicating examples of transitions between packet transfer states in the case where congestion occurs. In the explanations of FIG. 7, the following conditions are assumed.

There are three priority classes A, B, and C defined in increasing order of priority.

The reception interface 111 receives packets of priority class C from the network 21.

The reception interface 112 receives packets of priority class B from the network 22.

The reception interface 113 receives packets of priority class A from the network 23.

The destinations of all of the received packets are devices connected through the network 24.

The transmission rates in all of the networks 21 to 24 are identical.

The threshold values corresponding to the priority classes A, B, and C are defined in increasing order of the amount of use of the shared buffer, and set in the amount-of-use-of-shared-buffer detection circuit 160.

The processing indicated in FIG. 7 is explained below step by step.

[Step S21] When the amount of received packets is small (i.e., when the amount of use of the shared buffer 150 is still small and no congestion occurs), the data transfer circuit 130 transfers to the shared buffer 150 all packets received from the networks 21 to 24.

[Step S22] When the amount of received packets increases, the amount of use of the shared buffer exceeds the threshold value corresponding to the priority class A.

[Step S23] The amount-of-use-of-shared-buffer detection circuit 160 sends to the data transfer circuit 130 a reception reject signal corresponding to the priority class A by asserting a signal indicating a result of comparison made by the amount-of-use-of-shared-buffer detection circuit 160.

[Step S24] While the data transfer circuit 130 is receiving the reception reject signal corresponding to the priority class A, the data transfer circuit 130 masks a reception request from the reception interface 113 which receives packets of the priority class A. That is, the data transfer circuit 130 rejects the reception request, and makes the reception interface 113 discard packets.

[Step S25] The data transfer circuit 130 receives only packets from the reception interfaces 111 and 112 which receive packets of the priority classes C and B. The data transfer circuit 130 transfers to the shared buffer 150 the received packets of the priority classes C and B.

[Step S26] When the amount of received packets increases, the amount of use of the shared buffer exceeds the threshold value corresponding to the priority class B.

[Step S27] The amount-of-use-of-shared-buffer detection circuit 160 sends to the data transfer circuit 130 a reception reject signal corresponding to the priority class B by asserting a signal indicating a result of comparison made by the amount-of-use-of-shared-buffer detection circuit 160.

[Step S28] While the data transfer circuit 130 is receiving the reception reject signals corresponding to the priority classes A and B, the data transfer circuit 130 masks reception requests from the reception interfaces 113 and 112 which receive packets of the priority classes A and B. That is, the data transfer circuit 130 rejects the reception requests, and makes the reception interfaces 113 and 112 discard packets.

[Step S29] The data transfer circuit 130 receives only packets from the reception interface 111 which receives packets of the priority class C. The data transfer circuit 130 transfers to the shared buffer 150 the received packet of the priority class C.

Thus, when the amount of use of the shared buffer 150 increases, and congestion occurs, packets of the respective priority classes become subject to rejection of reception in increasing order of the priority classes. Therefore, it is possible to transfer packets of high priority classes with high reliability.

For example, under the above conditions, the transmission rates at the reception interfaces 111 to 113 and the transmission interface 124 are identical. Therefore, when the priority classes A and B are masked in step S28, the transmission rates in the reception interface 111 which is allowed to receive packets and the transmission interface 124 become identical. That is, the packet reception rate and the packet transmission rate becomes identical, and thereafter increase in the amount of use of the shared buffer 150 can be prevented. As a result, it is possible to transfer packets of the priority class C with high reliability without discard. In other words, higher communication quality can be guaranteed in a higher the priority class.

[Second Embodiment]

Next, the second embodiment is explained. In the second embodiment, a common priority-class determination circuit is provided.

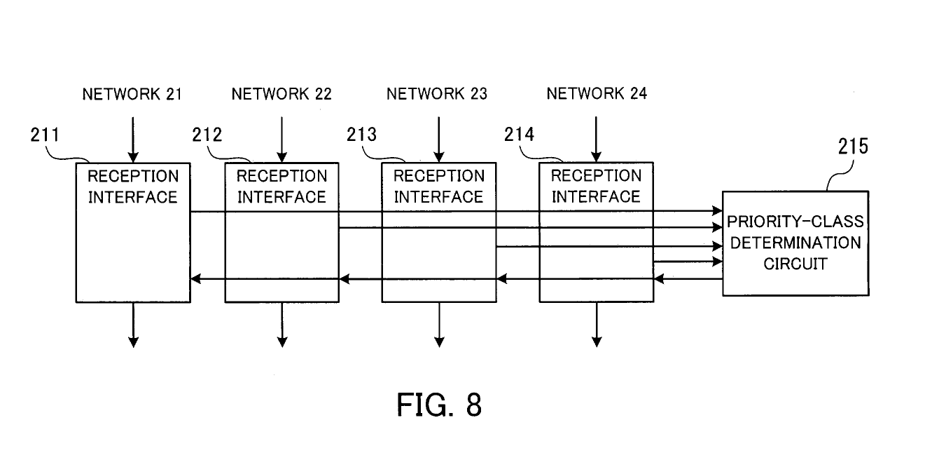

FIG. 8 is a diagram illustrating an example of a construction of a network switching device as the second embodiment. The construction of the second embodiment is different from the first embodiment illustrated in FIG. 3 in only the constructions of the reception interfaces 211 to 214 and the priority-class determination circuit 215. Therefore, only the reception interfaces 211 to 214 and the priority-class determination circuit 215 among the elements of the network switching device are illustrated in FIG. 8.

As illustrated in FIG. 8, in the network switching device as the second embodiment, the networks 21 to 24 are respectively connected to the reception interfaces 211 to 214, and the priority-class determination circuit 215 is connected to the reception interfaces 211 to 214. That is, the priority-class determination circuit 215 is provided common to the reception interfaces 211 to 214.

When the reception interfaces 211 to 214 receive packets from the networks 21 to 24, the reception interfaces 211 to 214 pass information on the packets (e.g., the content of the received packet) to the priority-class determination circuit 215, and request the priority-class determination circuit 215 to determine the priority classes of the packets. In response to the requests from the reception interfaces 211 to 214, the priority-class determination circuit 215 passes results of the determination to the reception interfaces which request the determination.

The internal construction of the priority-class determination circuit 215 is similar to the priority-class determination circuit 111a in the first embodiment illustrated in FIG. 4.

As described above, when the common priority-class determination circuit 215 is provided, the circuitry in the network switching device can be simplified. Thus, it is possible to reduce the size of the network switching device.

[Third Embodiment]

Next, the third embodiment is explained. In the third embodiment, the present invention is applied to a network switching device having a transmission-and-reception interfaces which transmit and receive packets. In the first embodiment, the reception interfaces and the transmission interfaces are explained as separate elements for easy understanding of the invention. However, in the practically used network switching devices, usually, packets are transmitted and received by transmission-and-reception interfaces which have functions of transmission and reception of packets. Therefore, an example of a construction of a network switching device as the third embodiment which comprises transmission-and-reception interfaces is explained.

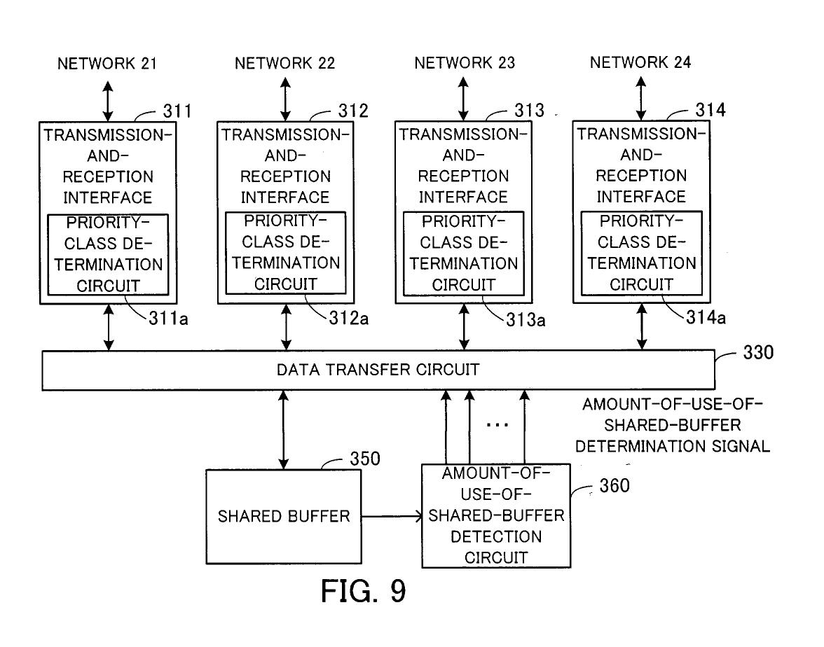

FIG. 9 is a diagram illustrating an example of a construction of the network switching device as the third embodiment. The network switching device as the third embodiment comprises a plurality of transmission-and-reception interfaces 311 to 314, a data transfer circuit 330, a shared buffer 350, and an amount-of-use-of-shared-buffer detection circuit 360.

The transmission-and-reception interfaces 311 to 314 are respectively connected to the networks 21 to 24, and transmit and receive packets through the networks 21 to 24. In other words, the transmission-and-reception interfaces 311 to 314 have the functions of the reception interfaces 111 to 114 and the transmission interfaces 211 to 214 in the first embodiment illustrated in FIG. 3.

In addition, the transmission-and-reception interfaces 311 to 314 comprise priority-class determination circuits 311a to 314a, respectively. The priority-class determination circuits 311a to 314a determine priority classes of received packets. The internal constructions of the priority-class determination circuits 311a to 314a are similar to the internal construction of the priority-class determination circuit 111a in the first embodiment illustrated in FIG. 4.

The data transfer circuit 330 determines whether to receive packets of each priority class, based on an amount-of-use-of-shared-buffer determination signal supplied from the amount-of-use-of-shared-buffer detection circuit 360. When the data transfer circuit 330 receives a reception request for a packet from the transmission-and-reception interfaces 311 to 314, the data transfer circuit 330 determines whether to allow reception of the packet, based on the priority class of the packet. When the reception is allowed, the data transfer circuit 330 receives the packet from the transmission-and-reception interfaces 311 to 314, and stores the packet in the shared buffer 350.

In addition, when the data transfer circuit 330 receives a transmission request for a packet from the transmission-and-reception interfaces 311 to 314, the data transfer circuit 330 acquires the packet from the shared buffer 350, and passes the packet to a transmission interface which outputs the transmission request. In other words, the data transfer circuit 330 has the functions of the data transfer circuits 130 and 140 in the first embodiment illustrated in FIG. 3.

The constructions of the shared buffer 350 and the amount-of-use-of-shared-buffer detection circuit 360 are respectively similar to the constructions of the shared buffer 150 and the amount-of-use-of-shared-buffer detection circuit 160 in the first embodiment illustrated in FIG. 5, except that only the data transfer circuit 330 inputs packets into the shared buffer 350, and reads out packets from the shared buffer 350.

In the network switching device having the above construction, when packets from the networks 21 to 24 are input into the transmission-and-reception interfaces 311 to 314, the priority-class determination circuits 311a to 314a determine the priority classes of the packets, and send to the data transfer circuit 330 reception requests which contain values indicating the priority classes of the packets. In response to each reception request for a packet, the data transfer circuit 330 determines whether or not to allow the reception of the packet, based on the priority class of the packet and the amount of use of the shared buffer. The packet is stored by the data transfer circuit 330 in the shared buffer 350 only when the reception of the packet is allowed. At this time, the amount-of-use-of-shared-buffer detection circuit 360 updates the amount of use of pointers which indicates the amount of use of the shared buffer.

Further, when the transmission-and-reception interfaces 311 to 314 become able to transmit packets, the transmission-and-reception interfaces 311 to 314 send to the data transfer circuit 330 transmission requests for packets. In response to each transmission request, the data transfer circuit 330 reads out from the shared buffer 350 a packet to be transmitted to a network connected to a transmission-and-reception interface which outputs the transmission request. At this time, the amount-of-use-of-shared-buffer detection circuit 360 updates the amount of use of pointers which indicates the amount of use of the shared buffer. The packet read out from the shared buffer 350 is passed to the transmission-and-reception interface which outputs the transmission request, and is then output to the network connected to the transmission-and-reception interface.

As described above, the functions of the present invention can be implemented in the network switching device having the transmission-and-reception interfaces. Although the priority-class determination circuits 311a to 314a are respectively provided in the transmission-and-reception interfaces 311 to 314 in the example of FIG. 9, a common priority-class determination circuit may be provided in a similar manner to the example of FIG. 8.

[Fourth Embodiment]

The fourth to eighth embodiments are examples of network switching devices in which the threshold values can be dynamically changed. For example, the threshold values are changed when a priority class of existing traffic or newly generated traffic is required to be changed. Thus, priority classes and threshold values can be set according to traffic conditions.

First, the fourth embodiment is explained. In the fourth embodiment, a processor is arranged between the network switching device and a portion of the networks, where the processor is a device which is generally called a central processing unit (CPU) or a microprocessor unit (MPU).

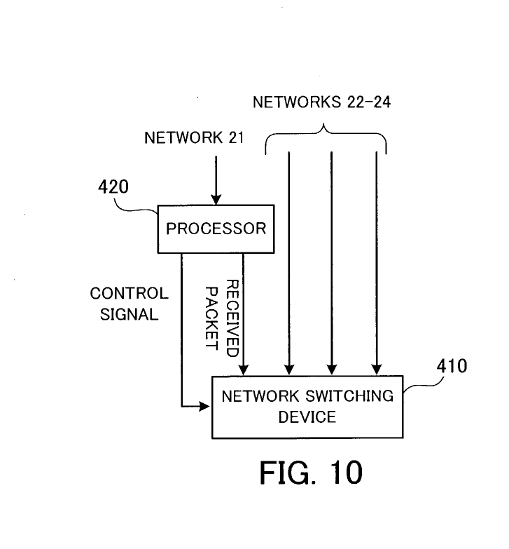

FIG. 10 is a diagram illustrating an example of a system construction in the fourth embodiment. A processor 420 is connected between the network 21 and the network switching device 410 in the fourth embodiment, while the other networks 22 to 24 are directly connected to the network switching device 410. The internal construction of the network switching device 410 is almost identical to the construction of the first embodiment illustrated in FIG. 3, except that a control signal from the processor 420 is connected to the threshold-value-setting registers in the amount-of-use-of-shared-buffer detection circuit and the priority-class tables in the priority-class determination circuits.

The processor 420 supplies a received packet and the control signal to the network switching device 410. The control signal is a signal for inputting into the network switching device 410 threshold values which are to be set in threshold-value-setting registers. When the processor 420 receives a packet from the network 21, the processor 420 passes the packet to the network switching device 410. At this time, the processor 420 monitors the conditions of communication (e.g., the contents of the received packet), and determines the priority class of the packet, a threshold value corresponding to the priority class, and the like according to the conditions of communication. In addition, the processor 420 sets the results of the determination in the priority-class tables and the threshold-value-setting registers in the network switching device 410 by using the control signal. Thus, the threshold values can be changed according to the conditions of packet reception.

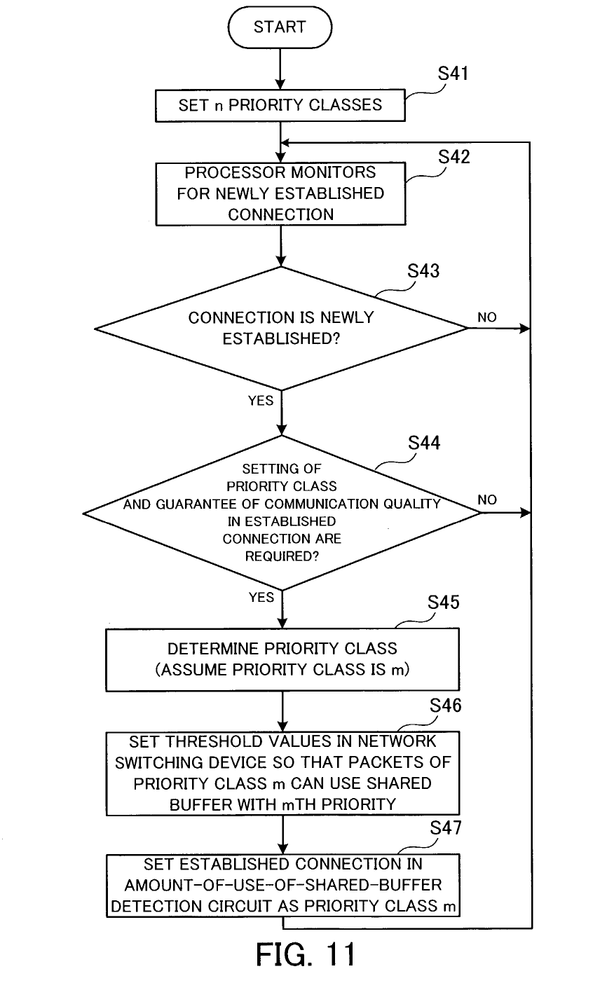

FIG. 11 is a flow diagram indicating an example of a sequence of processing performed by the processor for priority control when a connection is newly established. The processing indicated in FIG. 11 is an example of processing performed by the processor 420 for defining a priority class corresponding to a newly established connection. The processing of FIG. 11 is explained step by step.

[Step S41] The processor 420 sets n priority classes, where n is a natural number, and priority classes indicated by smaller values correspond to higher priorities.

[Step S42] The processor 420 monitors whether or not a connection is newly established.

[Step S43] The processor 420 determines whether or not a connection is newly established. When yes is determined in step S43, the operation goes to step S44. When no is determined in step S43, the operation goes to step S42, and the monitoring is continued.

[Step S44] The processor 420 determines whether or not the established connection is a connection in which setting of a priority class and guarantee of communication quality are required. For example, this determination can be made based on a source address in the connection. When yes is determined in step S44, the operation goes to step S45. When no is determined in step S44, the operation goes to step S42.

[Step S45] The processor 420 determines the priority class. Assume that the determined priority class is indicated by m (1≦m≦n+1).

[Step S46] The processor 420 sets threshold values in the network switching device 410 so that packets of the priority class m can use the shared buffer with the mth priority. At this time, lower threshold values of the amount of use of the shared buffer are set for priority classes indicated by larger numbers.

[Step S47] The processor 420 sets information in the amount-of-use-of-shared-buffer detection circuit so that the newly established connection corresponds to the priority class m in a priority-class tables in the network switching device 410. For example, a source address of a packet from a device which requests the establishment of the connection is registered in the field of the source address, and “m” is registered in the field of the priority class. Thereafter, the operation goes to step S42.

As described above, it is possible to realize fine-grained priority control of communication packets by arranging the processor 420 between the network switching device 410 and the network 21.

[Fifth Embodiment]

Next, the fifth embodiment is explained. In the fifth embodiment, all of the networks are connected to a network switching device through a processor.

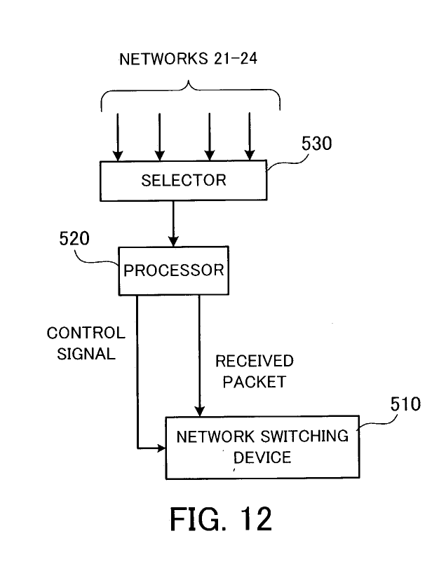

FIG. 12 is a diagram illustrating an example of a system construction in the fifth embodiment. In the fifth embodiment, the networks 21 to 24 are connected to the selector 530, which has a function of selecting one of packets transmitted from the networks 21 to 24. The selected packet is passed to the processor 520. The processor 520 and the network switching device 510 respectively have similar functions to the processor 420 and the network switching device 410 in the fourth embodiment indicated in FIG. 10.

When the system is constructed as above, the processor 520 can control the priority classes of packets transmitted from the networks 21 to 24.

[Sixth Embodiment]

Next, the sixth embodiment is explained. In the sixth embodiment, an arbitrary number of networks among the networks 21 to 24 are connected to a network switching device through a processor.

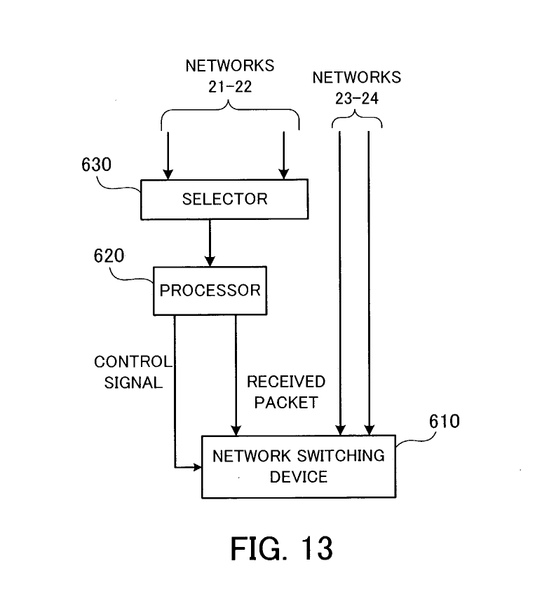

FIG. 13 is a diagram illustrating an example of a system construction in the sixth embodiment. In the sixth embodiment, the networks 21 and 22 are connected to the selector 630, which has a function of selecting one of packets transmitted from the networks 21 and 22. The selected packet is passed to the processor 620. The processor 620 and the network switching device 610 respectively have similar functions to the processor 420 and the network switching device 410 in the fourth embodiment indicated in FIG. 10. In addition, the networks 23 and 24 are directly connected to the network switching device 610.

When the system is constructed as above, packets for communication through the networks 21 and 22, which requires priority control, pass through the selector 630 and the processor 620. Therefore, it is possible to realize fine-grained priority control of the packets for communication through the networks 21 and 22.

[Seventh Embodiment]

Next, the seventh embodiment is explained. In the seventh embodiment, a processor interface is connected to a network switching device.

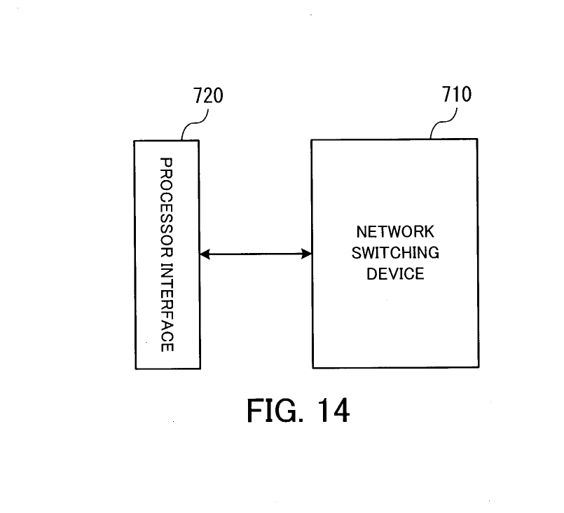

FIG. 14 is a diagram illustrating an example of a system construction in the seventh embodiment. As illustrated in FIG. 14, it is possible to connect the processor interface 720 to the network switching device 710. The processor interface 720 can be connected to a processor, and information can be set in the priority-class tables and the threshold-value-setting registers in the network switching device according to a request from the processor.

When the processor interface 720 is connected to the network switching device 710 as above, it is possible to facilitate connection between the processor and the network switching device.

[Eighth Embodiment]

Next, the eighth embodiment is explained. In the eighth embodiment, an interrupt signal is sent from a network switching device to a processor.

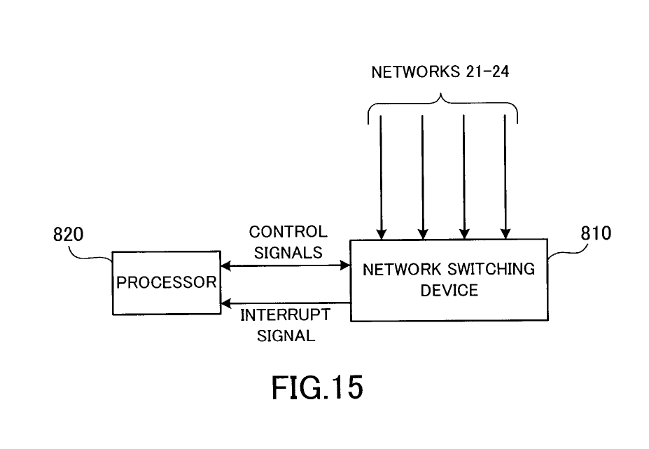

FIG. 15 is a diagram illustrating an example of a system construction in the eighth embodiment. As illustrated in FIG. 15, the processor 820 and the network switching device 810 are connected with control signals, and an interrupt signal is input from the network switching device 810 to the processor 820. In addition, the networks 21 to 24 are directly connected to the network switching device 810.

When a packet input from one of the networks 21 to 24 matches with information registered in the priority-class table, or when the amount of use of the shared buffer exceeds a threshold value corresponding to a priority class, the network switching device 810 asserts the interrupt signal applied to the processor 820. In response to the interrupt signal from the network switching device 810, the processor 820 executes predetermined interrupt processing. In addition, the processor 820 passes information corresponding to a result of the interrupt processing, to the network switching device 810 by using a control signal. The internal construction of the network switching device 810 is similar to the network switching device 100 in the first embodiment illustrated in FIG. 3.

In the above construction, the interrupt signal can be output from the priority-class determination circuits in the network switching device 810.

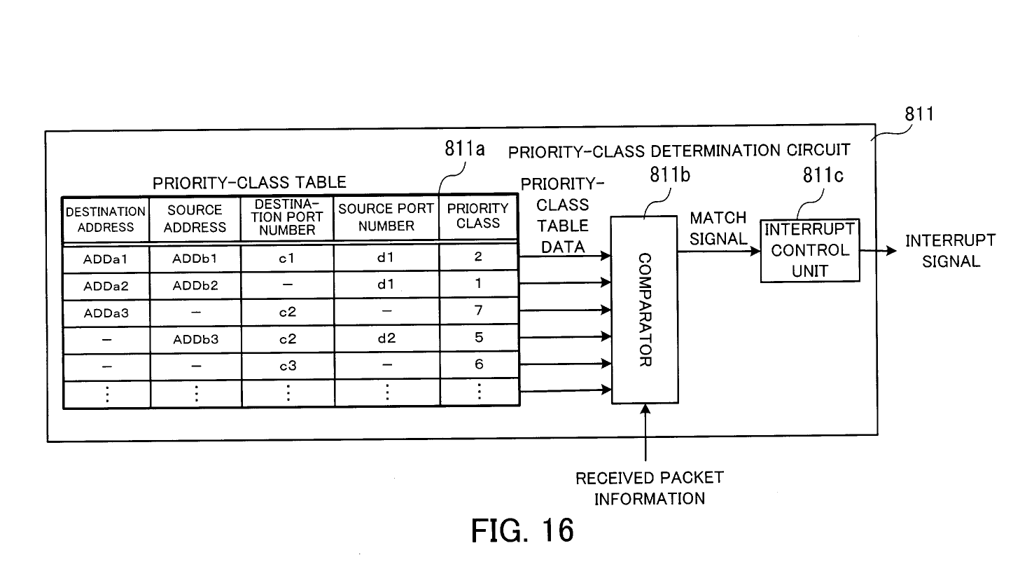

FIG. 16 is a block diagram illustrating an example of a construction of a priority-class determination circuit which outputs the interrupt signal. FIG. 16 shows an example of a priority-class determination circuit 811, which is arranged in a reception interface provided in the network switching device 810.

The priority-class determination circuit 811 comprises a priority-class table 811a, a comparator 811b, and an interrupt control unit 811c.

The priority-class table 811a is definition information for determining a priority class of a packet. The data structure of the priority-class table 811a is similar to that of the priority-class table 51 in the first embodiment illustrated in FIG. 4.

The comparator 811b compares information on a received packet (received packet information) with each entry in the priority-class table 811a (except for information on the priority class). When the received packet information matches with an entry, the comparator 811b asserts a match signal, which is input into the interrupt control unit 811c.

The interrupt control unit 811c outputs an interrupt signal to the processor 820. For example, when the interrupt control unit 811c detects the assertion of the match signal, the interrupt control unit 811c asserts an interrupt signal to the processor 820.

In the above construction, when a received packet matches with an entry in a priority-class table, the network switching device 810 can output an interrupt signal to the processor 820.

[Other Applications]

Although the fourth to eighth embodiments are explained as examples of variations of the first embodiment, the constructions of the fourth to eighth embodiments can be applied to the second and third embodiments.

In addition, the functions of each of the processor in the aforementioned embodiments can be realized by a processor which executes a program in which the details of the processing are described. For example, the program can be stored in a semiconductor memory such as a ROM (read-only memory) built in the network switching device.

As explained above, according to the present invention, received data is stored in a buffer when it is confirmed that the amount of current use of the buffer does not exceed a threshold value corresponding to a priority of the received data. Therefore, the threshold value, based on which use of the buffer is allowed, can be changed for each priority. Thus, when the amount of free capacity in the buffer becomes small, only data having high priority can be stored, and the transfer quality of the data can be guaranteed.

The foregoing is considered as illustrative only of the principle of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A network switching device for transferring data between a plurality of networks, comprising:
a buffer;
a priority determination circuit which determines a priority of received data when the received data is input;
an amount-of-use detection circuit which determines whether or not an amount of current use of said buffer exceeds a threshold value which is associated with a specific priority in advance; and
a data transfer circuit which acquires results of determination by said priority determination circuit and said amount-of-use detection circuit, and stores said received data in said buffer when said amount of current use of the buffer does not exceed the threshold value associated with said priority of the received data.

2. The network switching device according to claim 1, wherein said data transfer circuit discards said received data when said amount of current use of the buffer exceeds the threshold value associated with said priority of the received data.

3. The network switching device according to claim 1, wherein said priority determination circuit comprises a priority-class table in which at least one correspondence between at least one priority and information on at least one attribute of data is defined, and determines a priority corresponding to at least one attribute of said received data by referring to said priority-class table.

4. The network switching device according to claim 3, wherein said priority determination circuit determines said priority to be a default value which is preset, when said at least one attribute of said received data is not defined in said priority-class table.

5. The network switching device according to claim 3, wherein at least one attribute included in at least one content of at least one received packet is defined in said priority-class table, where said received data is contained in said at least one packet when the received data is transferred.

6. The network switching device according to claim 5, further comprising a processor which monitors conditions of data communication, and sets information in said priority-class table according to the conditions of data communication.

7. The network switching device according to claim 6, wherein said processor sets in said priority-class table information defining a priority of data transferred through a connection when the connection is newly established.

8. The network switching device according to claim 1, wherein said amount-of-use detection circuit comprises a plurality of registers in which a threshold value for each priority is set, and determines whether or not said amount of current use exceeds said threshold value for each priority by comparing the amount of current use with the threshold value set in said plurality of registers.

9. The network switching device according to claim 8, further comprising a processor which monitors conditions of data communication, and sets at least one value in said plurality of registers according to the conditions of data communication.

10. The network switching device according to claim 1, wherein said amount-of-use detection circuit comprises a pointer stack storing at least one pointer which points to a free space in said buffer, and determines said amount of current use of said buffer based on an amount of said at least one pointer stacked in said pointer stack.

11. The network switching device for transferring data between a plurality of networks, comprising:
a plurality of reception interfaces respectively connected to a plurality of networks and receiving data from said plurality of networks;
a buffer shared by said plurality of interfaces;
a priority determination circuit which determines a priority of received data when the received data is input into said plurality of interfaces;
an amount-of-use detection circuit which determines whether or not an amount of current use of said shared buffer exceeds a threshold value which is associated with each priority in advance; and
a data transfer circuit which acquires results of determination by said priority determination circuit and said amount-of-use detection circuit, and stores said received data in said shared buffer when said amount of current use of the shared buffer does not exceed the threshold value associated with said priority of the received data.

12. A network switching method for transferring data between a plurality of networks by storing input data in a buffer, comprising the steps of:
(a) determining a priority of received data from said plurality of network when the received data is input;
(b) determining whether or not an amount of current use of said buffer exceeds a threshold value which is associated with each priority in advance; and
(c) storing said received data in said buffer when said amount of current use of said buffer does not exceed the threshold value associated with said priority of the received data.
